(19) United States
(12) Patent Application Publication
(10) Pub. No.: US 2011/0131200 A1
(43) Pub. Date: Jun. 2, 2011

(54) COMPLEX PATH-BASED QUERY EXECUTION

(75) Inventors: Xiao Ming ZHOU, Singapore (SG); Tat-Keong Loh, Singapore (SG); Mohyuddin Rehmattullah, Fremont, CA (US); Michelle Lim, Singapore (SG)

(73) Assignee: Sybase, Inc., Dublin, CA (US)

(21) Appl. No.: 12/628,458

(22) Filed: Dec. 1, 2009

(51) Int. Cl. G06F 17/30

(52) U.S. Cl. 707/714; 707/769; 707/E17.014; 707/E17.054

(57) ABSTRACT

Systems, methods, computer program product embodiments are provided for executing a function in a path-based query when extracting data from a markup language document for return as a relational table, the markup language document organized hierarchically into nodes. An embodiment includes receiving a path-based query including a complex row pattern and column definition, forming multiple sets of nodes based on a simplified row pattern and column definition, determining ancestor-descendent pairings for the nodes in the column definition set, and utilizing the ancestor-descendent pairings with the simplified row pattern to return a relational table satisfying the complex path-based query. An embodiment further includes extensible markup language (XML) as the markup language, and an XPath query expression as the complex path-based query.

### FIELD OF THE INVENTION

The present invention relates generally to data processing environments and, more particularly, to a database system providing methodology for execution of complex path-based queries requesting data from markup language documents.

### BACKGROUND

Computers are very powerful tools for storing and providing access to vast amounts of information. Computer databases are a common mechanism for storing information on computer systems while providing easy access to users. A typical database is an organized collection of related information stored as “records” having “fields” of information. As an example, a database of employees may have a record for each employee where each record contains fields designating specifics about the employee, such as name, home address, salary, and the like.

Between the actual physical database itself (i.e., the data actually stored on a storage device) and the users of the system, a database management system or DBMS is typically provided as a software cushion or layer. In essence, the DBMS shields the database user from knowing or even caring about the underlying hardware-level details. Typically, all requests from users for access to the data are processed by the DBMS. For example, information may be added or removed from data files, information retrieved from or updated in such files, and so forth, all without user knowledge of the underlying system implementation. In this manner, the DBMS provides users with a conceptual view of the database that is removed from the hardware level. The general construction and operation of database management systems is well known in the art. See e.g., Date, C., “An Introduction to Database Systems, Seventh Edition”, Part I (especially, Chapters 1-4), Addison Wesley, 2000.

In recent years, applications running on database systems frequently provide for business-to-business or business-to-consumer interaction via the Internet between the organization hosting the application and its business partners and customers. Today, many organizations receive and transmit considerable quantities of information to business partners and customers through the Internet. A considerable portion of the information received or exchanged is in Extensible Markup Language or “XML” format. XML is a pared-down version of SGML (Standard Generalized Markup Language), designed especially for Web documents, which allows designers to create their own customized tags, enabling the definition, transmission, validation, and interpretation of data between applications and between organizations. For further description of XML, see e.g., “Extensible Markup Language (XML) 1.0” (Second Edition, Oct. 6, 2000) a recommended specification from the W3C, the disclosure of which is hereby incorporated by reference. A copy of this specification is available via the Internet (e.g., currently at www.w3.org/TR/2000/REC-xml-20001006). Many organizations utilize XML to exchange data with other remote users over the Internet.

Given the increasing use of XML in recent years, many organizations now have considerable quantities of data in XML format, including Web documents, newspaper articles, product catalogs, purchase orders, invoices, and product plans. As a result, these organizations need to be able to efficiently store, maintain, and use this XML information in an efficient manner. However, this XML data is not in a format that can be easily stored and searched in current database systems. Most XML data is sent and stored in plain text format. This data is not formatted in tables and rows like information stored in a relational DBMS. To search this semi-structured data, users typically utilize keyword searches similar to those utilized by many current Internet search engines. These keyword searches are resource-intensive and are not as efficient as relational DBMS searches of structured data.

Organizations with data in XML format also typically have other enterprise data stored in a structured format in database management systems. Increasingly, database system users are demanding that database systems provide the ability to access and use both structured data stored in these databases as well as XML and other unstructured or semi-structured data. In addition, users desire flexible tools and facilities for performing searches of this data.

One of the key roles of a database management system (DBMS) is to retrieve data stored in a database based on specified selection criterion. This typically involves retrieving data in response to a query that is specified in a query language. One current solution used in XML-based applications to query the contents of an XML document is XPath. XPath provides basic facilities for manipulation of strings, numbers and booleans. It uses a compact, non-XML syntax to facilitate use of XPath within URIs and XML attribute values. XPath operates on the abstract, logical structure of an XML document, rather than its surface syntax. XPath gets its name from its use of a path notation as in URLs for navigating through the hierarchical structure of an XML document. For further description of XPath, see e.g., “XML Path Language (XPath) Version 2.0” (Jan. 23, 2007), a recommended specification from the W3C, the disclosure of which is hereby incorporated by reference. A copy of this specification is available via the Internet (e.g., currently at http://www.w3.org/TR/XPath20/).

The XPath query language is commonly used in Extensible Stylesheet Language Transformations (XSLT) to locate and to apply XSLT templates to specific nodes in an XML document. In general, an XPath expression specifies a pattern that selects a set of XML nodes. Thus, XPath queries are commonly used to locate and to process nodes in an XML document that match a specified criteria.

For example, a simple XPath query may take a form such as /A/B/C to select C elements that are children of B elements that are children of the A element that forms the outermost element of the XML document. Selection may take on a more complex form, however, with construction of complex XPath expressions. More complex XPath expressions can be constructed, such as by containing other XPath query language constructs, e.g., filter, functions, parenthesis, union, intersection, etc., specifying an axis other than the default ‘child’ axis, a node test other than a simple name, or predicates. For example, the complex XPath expression APB/*[1] should return the first element (as designated by the use of ‘[1]’), with any name (as designated by the use of ‘*’), that is a child (‘/’) of a B element that itself is a child or other deeper descendant (‘//’) of an A element that is a child of the current context node (the expression does not begin with a ‘/’). When there are several suitable B elements in the document, a set of all their first children needs to be returned.

While XPath has been used as the query language for XML documents with some success, complex XPath querying is not handled effectively in current XML processing engines. One particular need is for a solution that will enable efficient and accurate searches of information in XML documents when queried using complex expression for extraction into a relational table. The present invention addresses this need.

### BRIEF SUMMARY

Briefly stated, the invention includes system, method, computer program product embodiments and combinations and sub-combinations thereof for executing a function in a path-based query when extracting data from a markup language document for return as a relational table, the markup language document organized hierarchically into nodes. An embodiment includes receiving a path-based query including a complex row pattern and column definition, forming multiple sets of nodes based on a simplified row pattern and column definition, determining ancestor-descendent pairings for the nodes in the column definition set, and utilizing the ancestor-descendent pairings with the simplified row pattern to return a relational table satisfying the complex path-based query. An embodiment further includes extensible markup language (XML) as the markup language, and an XPath query expression as the complex path-based query.

Further embodiments, features, and advantages of the invention, as well as the structure and operation of the various embodiments of the invention, are described in detail below with reference to accompanying drawings.

### BRIEF DESCRIPTION OF THE FIGURES

Embodiments of the invention are described with reference to the accompanying drawings. In the drawings, like reference numbers may indicate identical or functionally similar elements. The drawing in which an element first appears is generally indicated by the left-most digit in the corresponding reference number.

FIG. 1 is a very general block diagram of a computer system (e.g., an IBM-compatible system) in which software-implemented processes of the present invention may be embodied.

FIG. 2 is a block diagram of a software system for controlling the operation of the computer system.

FIG. 3 illustrates the general structure of a client/server database system suitable for implementing the present invention.

FIG. 4 is a block diagram illustrating a tree representation of an XML document.

FIG. 5 is a block diagram illustrating an environment in which the present invention may be implemented.

FIG. 6 illustrates an example execution plan that manipulates the plans for the XMLTABLE for a complex row pattern with an LOJ Group operator.

FIG. 7 illustrates an example execution plan modifying the plan of FIG. 6.

FIG. 8 illustrates an execution plan in accordance with an embodiment of the invention for achieving complex path based query support.

FIG. 9 is a block flow diagram illustrating a method of complex path-based query support in accordance with embodiments of the present invention.

The features and advantages of the present invention will become more apparent from the detailed description set forth below when taken in conjunction with the drawings.

### DETAILED DESCRIPTION

While embodiments are described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

Glossary

The following definitions are offered for purposes of illustration, not limitation, in order to assist with understanding the discussion that follows.

ASE: Sybase® Adaptive Server® Enterprise, an enterprise relational database system available from Sybase, Inc. of Dublin, Calif.

HTML: HTML stands for HyperText Markup Language, the authoring language used to create documents on the World Wide Web. HTML defines the structure and layout of a Web document by using a variety of tags and attributes.

Node: In the context of a markup language document (e.g., an XML document), a node corresponds to an element or value in the markup language document. Unlike conventional data in a database (e.g., relational database) which is maintained in a flat structure, information in a markup language document (e.g., XML document) can be represented as a tree structure. The tree structure of an XML document is generated by transforming each element or value in the XML document into a node in the tree.

Path scan: A path scan returns identifiers of all the nodes that follow a given XPath. In the system of the present invention, a path scan invokes services of a store layer.

Physical query operator (operator): One step in an execution plan is called an operator. The implementation of the execution for one step in the plan (operator) is called the “physical” operator.

Query: A request for information from a database. A database query is typically written in a database query language, which is a language enabling database users to interactively formulate requests and generate reports. One of the best known query languages is the Structured Query Language (SQL).

Query engine: A query engine is a significant component of a DBMS, which in the currently preferred embodiment of the present invention is comprised of the following sub-components: a parser, a normalization engine, an optimizer/compiler, and an execution engine. The parser converts query text to a query tree and imposes syntactic correctness. The normalization engine enforces semantic correctness by validating the correctness of information in the query. It also transforms the query into an operator tree or query that is in a form which facilitates processing by other sub-components of the query engine. An optimizer chooses the best among various alternative plans for executing a query. A compiler generates another structure that enumerates the specific execution steps in the appropriate order of execution. In this document the XML engine optimizer and compiler are together referred to as the optimizer, unless otherwise indicated. The last sub-component of the query engine is the execution engine which is a virtual machine within a DBMS that interprets the “plan language”. The execution engine executes all the sub-commands necessary to execute the query and return results.

Query plan: A query plan (execution plan or “plan”) is an in-memory data-structure which contains the specific steps (operations) and order of execution for a given query. A query plan is written in a language that the execution engine understands.

Query processing: All phases of query evaluation, parsing, normalization, optimization/compilation, execution, and result generation, together are termed as “query processing”. The life of a query includes all of these phases.

Query tree: A query tree is an in-memory data-structure which represents a query. Initially, it is a mirror of “query text” in the form of an in-memory data-structure. It includes the same information as in the user query.

Relational database: A relational database is a collection of data items organized as a set of formally-described tables from which data can be accessed or reassembled in many different ways without having to reorganize the database tables. The relational database was invented by E. F. Codd at IBM in 1970. A relational database employs a set of tables containing data fitted into predefined categories. Each table (which is sometimes called a relation) contains one or more data categories in columns. The standard user and application program interface to a relational database is the structured query language (SQL), defined below.

SQL: SQL stands for Structured Query Language. The original version called SEQUEL (structured English query language) was designed by IBM in the 1970's. SQL-92 (or SQL/92) is the formal standard for SQL as set out in a document published by the American National Standards Institute in 1992; see e.g., “Information Technology—Database languages—SQL”, published by the American National Standards Institute as American National Standard ANSI/ISO/IEC 9075: 1992, the disclosure of which is hereby incorporated by reference. SQL-92 was superseded by SQL-99 (or SQL3) in 1999; see e.g., “Information Technology—Database Languages—SQL, Parts 1-5” published by the American National Standards Institute as American National Standard INCITS/ISO/IEC 9075-(1-5)-1999 (formerly ANSI/ISO/IEC 9075-(1-5) 1999), the disclosure of which is hereby incorporated by reference.

Storage layer: A storage layer is a component of a DBMS which provides services to the query engine such as running a scan and extracting data from disk to in-memory buffers, storing data from in-memory buffers to disk, and so forth.

URL: URL is an abbreviation of Uniform Resource Locator, the global address of documents and other resources on the World Wide Web. The first part of the address indicates what protocol to use, and the second part specifies the IP address or the domain name where the resource is located.

XML: XML stands for Extensible Markup Language, a specification developed by the World Wide Web Consortium (W3C). XML is a pared-down version of the Standard Generalized Markup Language (SGML), a system for organizing and tagging elements of a document. XML is designed especially for Web documents. It allows designers to create their own customized tags, enabling the definition, transmission, validation, and interpretation of data between applications and between organizations.

XPath: XPath is a query language for querying data in XML documents. The XPath query language is commonly used in Extensible Stylesheet Language Transformations (XSLT) to locate and to apply XSLT templates to specific nodes in an XML document. XPath queries are also commonly used to locate and to process nodes in an XML document that match a specified criteria. XPath provides basic facilities for manipulation of strings, numbers, and booleans. It uses a compact, non-XML syntax to facilitate use of XPath within URLs and XML attribute values. XPath operates on the abstract, logical structure of an XML document, rather than its surface syntax. XPath gets its name from its use of a path notation as in URLs for navigating through the hierarchical structure of an XML document.

Referring to the figures, exemplary embodiments of the invention will now be described. The following description will focus on the presently preferred embodiment of the present invention, which is implemented in desktop and/or server software (e.g., driver, application, or the like) operating in an Internet-connected environment running under an operating system, such as the Microsoft Windows operating system. The present invention, however, is not limited to any one particular application or any particular environment. Instead, those skilled in the art will find that the system and methods of the present invention may be advantageously embodied on a variety of different platforms, including Macintosh, Linux, Solaris, UNIX, FreeBSD, and the like. Therefore, the description of the exemplary embodiments that follows is for purposes of illustration and not limitation. The exemplary embodiments are primarily described with reference to block diagrams or flowcharts. As to the flowcharts, each block within the flowcharts represents both a method act and an apparatus element for performing the method act. Depending upon the implementation, the corresponding apparatus element may be configured in hardware, software, firmware, or combinations thereof.

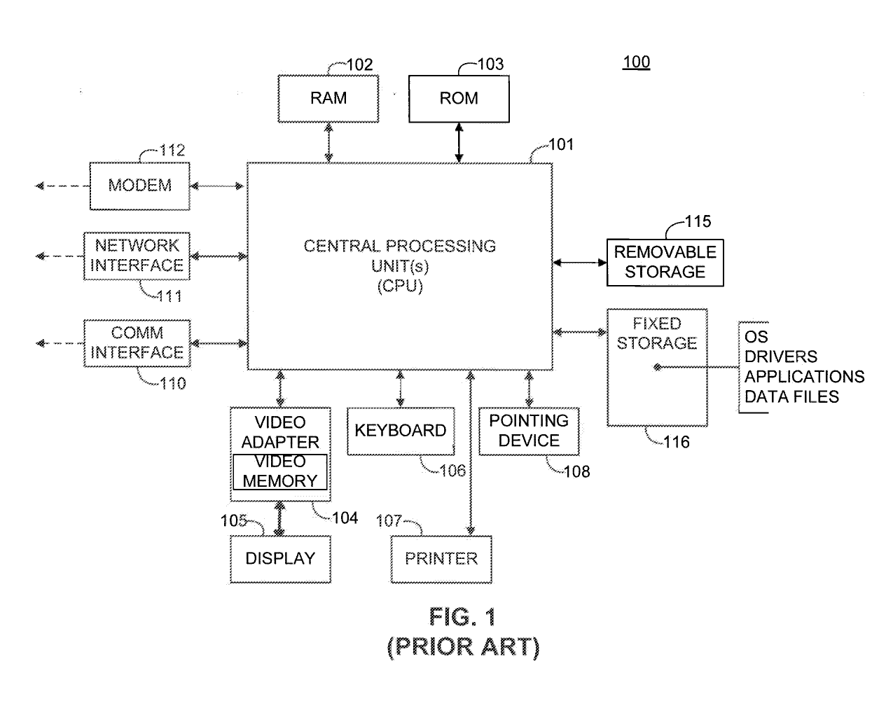

The present invention may be implemented on a conventional or general-purpose computer system, such as an IBM-compatible personal computer (PC) or server computer. FIG. 1 is a very general block diagram of a computer system (e.g., an IBM-compatible system) in which software-implemented processes of the present invention may be embodied. As shown, system 100 comprises a central processing unit(s) (CPU) or processor(s) 101 coupled to a random-access memory (RAM) 102, a read-only memory (ROM) 103, a keyboard 106, a printer 107, a pointing device 108, a display or video adapter 104 connected to a display device 105, a removable (mass) storage device 115 (e.g., floppy disk, CD-ROM, CD-R, CD-RW, DVD, or the like), a fixed (mass) storage device 116 (e.g., hard disk), a communication (COMM) port(s) or interface(s) 110, a modem 112, and a network interface card (NIC) or controller 111 (e.g., Ethernet). Although not shown separately, a real time system clock is included with the system 100, in a conventional manner.

CPU 101 comprises a processor, such as one of the Intel Pentium family of microprocessors or any other suitable processor that may be utilized for implementing the present invention. The CPU 101 communicates with other components of the system via a bi-directional system bus (including any necessary input/output (I/O) controller circuitry and other “glue” logic). The bus, which includes address lines for addressing system memory, provides data transfer between and among the various components. Random-access memory (RAM) 102 serves as the working memory for the CPU 101. The read-only memory (ROM) 103 contains the basic input/output system code (BIOS)—a set of low-level routines in the ROM that application programs and the operating systems can use to interact with the hardware, including reading characters from the keyboard, outputting characters to printers, and so forth.

Mass storage devices 115, 116 provide persistent storage on fixed and removable media, such as magnetic, optical or magnetic-optical storage systems, flash memory, or any other available mass storage technology. The mass storage may be shared on a network, or it may be a dedicated mass storage. As shown in FIG. 1, fixed storage 116 stores a body of program and data for directing operation of the computer system, including an operating system, user application programs, driver and other support files, as well as other data files of all sorts. Typically, the fixed storage 116 serves as the main hard disk for the system.

In basic operation, program logic (including that which implements methodology of the present invention described below) is loaded from the removable storage 115 or fixed storage 116 into the main (RAM) memory 102, for execution by the CPU 101. During operation of the program logic, the system 100 accepts user input from a keyboard 106 and pointing device 108, as well as speech-based input from a voice recognition system (not shown). The keyboard 106 permits selection of application programs, entry of keyboard-based input or data, and selection and manipulation of individual data objects displayed on the screen or display device 105. Likewise, the pointing device 108, such as a mouse, track ball, pen device, or the like, permits selection and manipulation of objects on the display device. In this manner, these input devices support manual user input for any process running on the system.

The computer system 100 displays text and/or graphic images and other data on the display device 105. The video adapter 104, which is interposed between the display 105 and the system's bus, drives the display device 105. The video adapter 104, which includes video memory accessible to the CPU 101, provides circuitry that converts pixel data stored in the video memory to a raster signal suitable for use by a display device, such as a cathode ray tube (CRT) raster or liquid crystal display (LCD) monitor. A hard copy of the displayed information, or other information within the system 100, may be obtained from the printer 107, or other output device.

The system itself communicates with other devices (e.g., other computers) via the network interface card (NIC) 111 connected to a network (e.g., Ethernet network, Bluetooth wireless network, or the like), and/or modem 112 (e.g., 56K baud, ISDN, DSL, or cable modem). The system 100 may also communicate with local occasionally-connected devices (e.g., serial cable-linked devices) via the communication (COMM) interface 110, which may include a RS-232 serial port, a Universal Serial Bus (USB) interface, or the like. Devices that will be commonly connected locally to the interface 110 include laptop computers, handheld organizers, digital cameras, and the like.

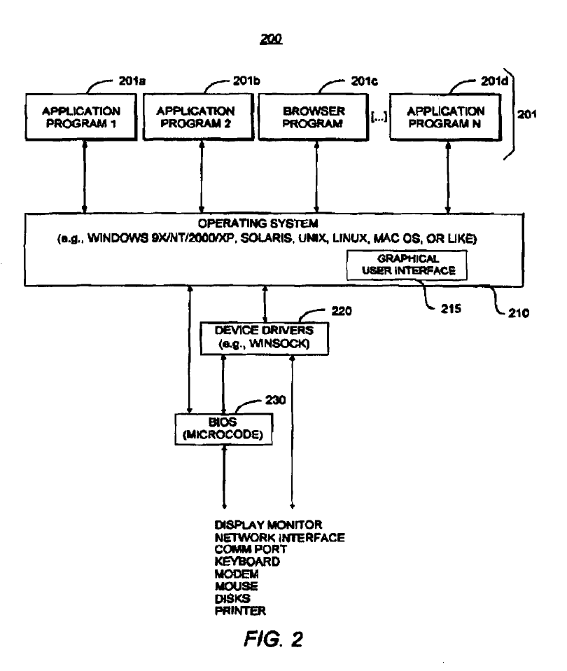

FIG. 2 is a block diagram of a software system for controlling the operation of the computer system 100. As shown, a computer software system 200 is provided for directing the operation of the computer system 100. Software system 200, which is stored in system memory (RAM) 102 and on fixed storage (e.g., hard disk) 116, includes a kernel or operating system (OS) 210. The OS 210 manages low-level aspects of computer operation, including managing execution of processes, memory allocation, file input and output (I/O), and device I/O. One or more application programs, such as client application software or “programs” 201 (e.g., 201a, 201b, 201c, 201d) may be “loaded” (i.e., transferred from fixed storage 116 into memory 102) for execution by the system 100. The applications or other software intended for use on the computer system 100 may also be stored as a set of downloadable processor-executable instructions, for example, for downloading and installation from an Internet location (e.g., Web server).

Software system 200 includes a graphical user interface (GUI) 215, for receiving user commands and data in a graphical (e.g., “point-and-click”) fashion. These inputs, in turn, may be acted upon by the system 100 in accordance with instructions from operating system 210, and/or client application module(s) 201. The GUI 215 also serves to display the results of operation from the OS 210 and application(s) 201, whereupon the user may supply additional inputs or terminate the session. Typically, the OS 210 operates in conjunction with device drivers 220 (e.g., “Winsock” driver—Windows' implementation of a TCP/IP stack) and the system BIOS microcode 230 (i.e., ROM-based microcode), particularly when interfacing with peripheral devices. OS 210 can be provided by a conventional operating system, such as Microsoft (registered trademark) Windows 9x, Microsoft (registered trademark) Windows NT, Microsoft (registered trademark) Windows 2000, or Microsoft (registered trademark) Windows XP, all available from Microsoft Corporation of Redmond, Wash. Alternatively, OS 210 can also be an alternative operating system, such as the previously mentioned operating systems.

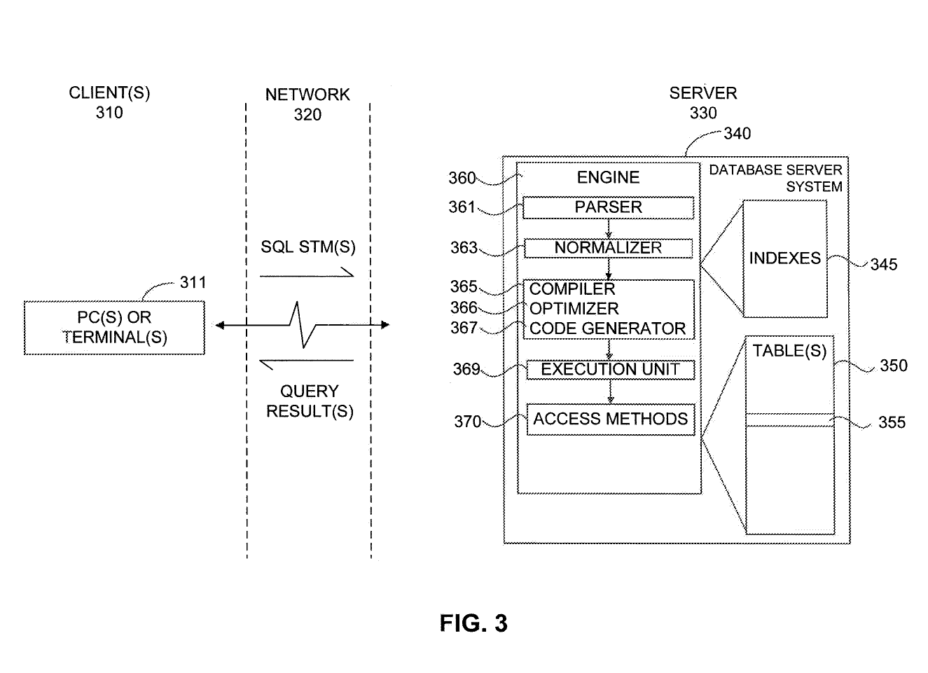

While the present invention may operate within a single (standalone) computer (e.g., system 100 of FIG. 1), the present invention is preferably embodied in a multi-user computer system, such as a client/server system. FIG. 3 illustrates the general structure of a client/server database system 300 suitable for implementing the present invention. As shown, the system 300 comprises one or more client(s) 310 connected to a server 330 via a network 320. Specifically, the client(s) 310 comprise one or more standalone terminals 311 connected to a database server system 340 using a conventional network. In an exemplary embodiment, the terminals 311 may themselves comprise a plurality of standalone workstations, dumb terminals, or the like, or comprise personal computers (PCs) such as the above-described system 100. Typically, such units would operate under a client operating system, such as a Microsoft (registered trademark) Windows client operating system (e.g., Microsoft (registered trademark) Windows 95/98, Windows 2000, or Windows XP).

The database server system 340, which comprises Sybase (registered trademark) Adaptive Server (registered trademark) Enterprise (available from Sybase, Inc. of Dublin, Calif.) in an exemplary embodiment, generally operates as an independent process (i.e., independently of the clients), running under a server operating system such as Microsoft (registered trademark) Windows NT, Windows 2000, or Windows XP (all from Microsoft Corporation of Redmond, Wash.), UNIX (Novell), Solaris (Sun), or Linux (Red Hat). The network 320 may be any one of a number of conventional network systems, including a Local Area Network (LAN) or Wide Area Network (WAN), as is known in the art (e.g., using Ethernet, IBM Token Ring, or the like). The network 320 includes functionality for packaging client calls in the well-known Structured Query Language (SQL) together with any parameter information into a format (of one or more packets) suitable for transmission to the database server system 340.

Client/server environments, database servers, and networks are well documented in the technical, trade, and patent literature. In operation, the client(s) 310 store data in, or retrieve data from, one or more database tables 350, as shown at FIG. 3. Data in a relational database is stored as a series of tables, also called relations. Typically resident on the server 330, each table itself comprises one or more “rows” or “records” (tuples) (e.g., row 355 as shown at FIG. 3). A typical database will contain many tables, each of which stores information about a particular type of entity. A table in a typical relational database may contain anywhere from a few rows to millions of rows. A row is divided into fields or columns; each field represents one particular attribute of the given row. A row corresponding to an employee record, for example, may include information about the employee's ID Number, Last Name and First Initial, Position, Date Hired, Social Security Number, and Salary. Each of these categories, in turn, represents a database field. In the foregoing employee table, for example, Position is one field, Date Hired is another, and so on. With this format, tables are easy for users to understand and use. Moreover, the flexibility of tables permits a user to define relationships between various items of data, as needed. Thus, a typical record includes several categories of information about an individual person, place, or thing. Each row in a table is uniquely identified by a record ID (RID), which can be used as a pointer to a given row.

Most relational databases implement a variant of SQL. SQL statements may be divided into two categories: data manipulation language (DML), used to read and write data; and data definition language (DDL), used to describe data and maintain the database. DML statements are also called queries. In operation, for example, the clients 310 issue one or more SQL commands to the server 330. SQL commands may specify, for instance, a query for retrieving particular data (i.e., data records meeting the query condition) from the database table(s) 350. In addition to retrieving the data from database server table(s) 350, the clients 310 also have the ability to issue commands to insert new rows of data records into the table(s), or to update and/or delete existing records in the table(s).

SQL statements or simply “queries” must be parsed to determine an access plan (also known as “execution plan” or “query plan”) to satisfy a given query. In operation, the SQL statements received from the client(s) 310 (via network 320) are processed by the engine 360 of the database server system 340. The engine 360 itself comprises a parser 361, a normalizer 363, a compiler 365, an execution unit 369, and access methods 370. Specifically, the SQL statements are passed to the parser 361 which converts the statements into a query tree—a binary tree data structure which represents the components of the query in a format selected for the convenience of the system. In this regard, the parser 361 employs conventional parsing methodology (e.g., recursive descent parsing).

The query tree is normalized by the normalizer 363. Normalization includes, for example, the elimination of redundant data. Additionally, the normalizer 363 performs error checking, such as confirming that table names and column names which appear in the query are valid (e.g., are available and belong together). Finally, the normalizer 363 can also look-up any referential integrity constraints which exist and add those to the query.

After normalization, the query tree is passed to the compiler 365, which includes an optimizer 366 and a code generator 367. The optimizer 366 is responsible for optimizing the query tree. The optimizer 366 performs a cost-based analysis for formulating a query execution plan. The optimizer will, for instance, select the join order of tables (e.g., when working with more than one table), and will select relevant indexes (e.g., when indexes are available). The optimizer, therefore, performs an analysis of the query and selects the best execution plan, which in turn results in particular access methods being invoked during query execution. It is possible that a given query may be answered by tens of thousands of access plans with widely varying cost characteristics. Therefore, the optimizer must efficiently select an access plan that is reasonably close to an optimal plan. The code generator 367 translates the query execution plan selected by the query optimizer 366 into executable form for execution by the execution unit 369 using the access methods 370.

All data in a typical relational database system is stored in pages on a secondary storage device, usually a hard disk. Typically, these pages may range in size from 1 Kb to 32 Kb, with the most common page sizes being 2 Kb and 4 Kb. All input/output operations (I/O) against secondary storage are done in page-sized units—that is, the entire page is read/written at once. Pages are also allocated for one purpose at a time: a database page may be used to store table data or used for virtual memory, but it will not be used for both. The memory in which pages reside that have been read from disk is called the cache or buffer pool.

I/O to and from the disk tends to be the most costly operation in executing a query. This is due to the latency associated with the physical media, in comparison with the relatively low latency of main memory (e.g., RAM). Query performance can thus be increased by reducing the number of I/O operations that must be completed. This can be done by using data structures and algorithms that maximize the use of pages that are known to reside in the cache. Alternatively, it can be done by being more selective about what pages are loaded into the cache in the first place. An additional consideration with respect to I/O is whether it is sequential or random. Due to the construction of hard disks, sequential I/O is much faster then random access I/O. Data structures and algorithms encouraging the use of sequential I/O can realize greater performance.

For enhancing the storage, retrieval, and processing of data records, the server 330 maintains one or more database indexes 345 on the database tables 350. Indexes 345 can be created on columns or groups of columns in a table. Such an index allows the page containing rows that match a certain condition imposed on the index columns to be quickly located on disk, rather than requiring the engine to scan all pages in a table to find rows that fulfill some property, thus facilitating quick access to the data records of interest. Indexes are especially useful when satisfying equality and range predicates in queries (e.g., a column is greater than or equal to a value) and “order by” clauses (e.g., show all results in alphabetical order by a given column).

A database index allows the records of a table to be organized in many different ways, depending on a particular user's needs. An index key value is a data quantity composed of one or more fields from a record which are used to arrange (logically) the database file records by some desired order (index expression). Here, the column or columns on which an index is created form the key for that index. An index may be constructed as a single disk file storing index key values together with unique record numbers. The record numbers are unique pointers to the actual storage location of each record in the database file.

Indexes are usually implemented as multi-level tree structures, typically maintained as a B-Tree data structure. Pointers to rows are usually stored in the leaf nodes of the tree, so an index scan may entail reading several pages before reaching the row. In some cases, a leaf node may contain the data record itself. Depending on the data being indexed and the nature of the data being stored, a given key may or may not be intrinsically unique. A key that is not intrinsically unique can be made unique by appending a RID. This is done for all non-unique indexes to simplify the code for index access. The traversal of an index in search of a particular row is called a probe of the index. The traversal of an index in search of a group of rows fulfilling some condition is called a scan of the index. Index scans frequently look for rows fulfilling equality or inequality conditions; for example, an index scan would be used to find all rows that begin with the letter ‘A’.

The above-described computer hardware and software are presented for purposes of illustrating the basic underlying desktop and server computer components that may be employed for implementing the present invention. For purposes of discussion, the following description will present examples in which it will be assumed that there exists a “server” (e.g., database server) that communicates with one or more “clients” (e.g., personal computers such as the above-described system 100). The following discussion also uses examples of queries requesting information from XML documents stored in a database system; however, the present invention may also be used in conjunction with documents written in various other markup languages, including, but not limited to, cHTML, HTML, and XHTML. The present invention, however, is not limited to any particular environment or device configuration. In particular, a client/server distinction is not necessary to the invention, but is used to provide a framework for discussion. Instead, the present invention may be implemented in any type of system architecture or processing environment capable of supporting the methodologies of the present invention presented in detail below.

The present invention comprises a system providing methodology for executing complex path-based queries requesting data from markup language documents. The following discussion focuses on an XML document; however the system and methodology of the present invention may also be used for other types of markup language or tag-delimited sources of information. Accordingly, the references to XML in the following discussion are used for purposes of illustration and not limitation.

XML is a widely accepted model for representing data. In recent years, XML has become pervasive both in representing stored data and communicating data over a network. The following discussion illustrates the operations of the present invention using several examples of an XML document including books in a bookstore. A simple example of an XML document is as follows:

<bookstore>
<book publisher= ”MGH”>

<title>Trenton</title>
<author>

<fname>Mary</fname>
<lname>Bob</lname>

</author>

</book>
<book publisher= ”AW”>

<title>National</title>
<author>

<fname>Joe</fname>
<lname>Bob</lname>

</author>

</book>
</bookstore>

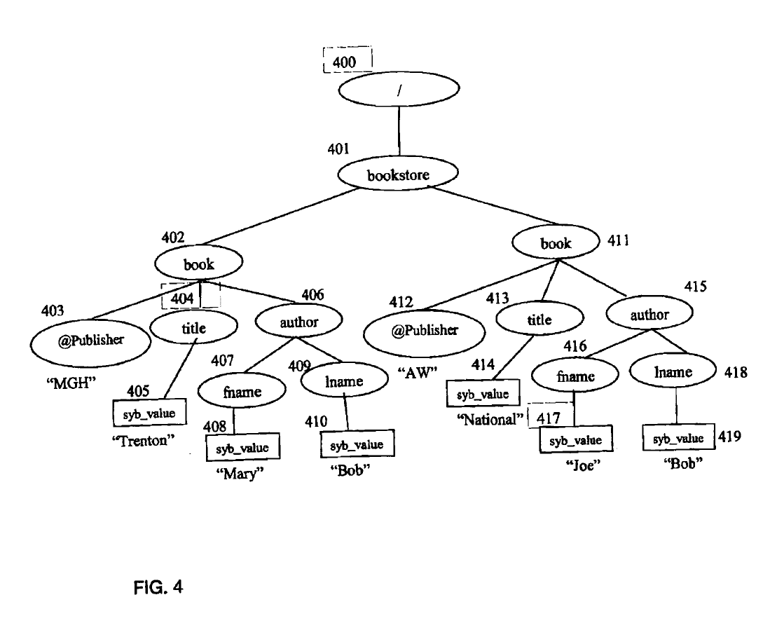

Unlike conventional data in a relational database which is maintained in a flat structure, information in an XML document is usually maintained in a tree structure. FIG. 4 is a block diagram illustrating a tree representation of the above XML document. As shown at FIG. 4, each element or value in the XML document has been converted to a node in the tree. These nodes are numbered in a pre-determined manner. The number corresponding to each node is called a “node id” of the element or tree node. This concept of node id is important in XML query processing. As shown, nodes of the tree include a bookstore 401, a first book 402, and a second book 411. Children nodes of book 402 provide access to additional information regarding each book, including publisher 403, title 404, and author 406, including author first name (frame) 407 and author last name (lname) 409. Book 411 similarly has associated children nodes 412, 413, 415, 416, and 418. As shown, the title, first name (frame), and last name (lname) nodes of each book have associated data values.

As previously described, XPath is a query language for querying data in XML documents. An example of an XPath query for requesting data in the above example XML document is as follows:

/bookstore/book/title

An example of a SQL version of the above XPath query that can be used in the currently preferred embodiment of the system of the present invention is as follows:

{select xmlextract(‘/bookstore/book/title’, xmlcol) from bookstoretable}

where “xmlextract’ represents a built-in function of ASE SQL to run the XPath query. The above XPath query would return the following answer based on the example XML document shown above:

Answer: <title>Trenton</title><title>National</title>

Another example of an XPath query is:

/bookstore/book[title=‘Trenton’]/author/lname

A SQL version of this query is as follows:

{select xmlextract(‘/bookstore/book[title=‘Trenton’]/author/lname, xmlcol) from bookstoretable}

As shown, the above SQL query specifies the path from which data is to be selected (in the form select xmlextract(path)) as well as the column name (xmlcol) and table (bookstoretable). Also, in the above query the “[” operator (or “square bracket” operator) provides for filtering out books based on comparing the title of the book to ‘Trenton’. This operator corresponds to a “where” clause in a SQL query. The last name of the author of such books is then projected. The above query would return the following answer based on the example XML document shown above:

Answer: <lname>Bob</lname>

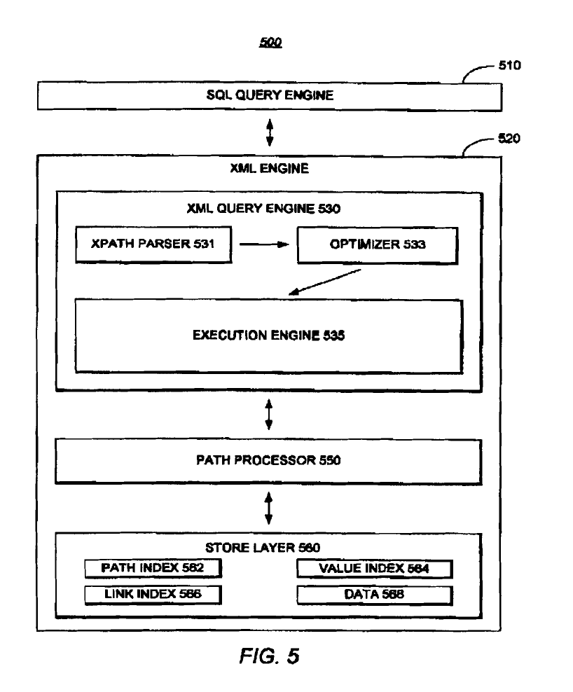

FIG. 5 is a block diagram illustrating an environment 500 in which such XPath queries can be performed and the present invention may be implemented. The environment 500 includes an SQL Query Engine 510 and an XML Engine 520. The XML Engine 520 provides mechanisms for storage and retrieval of information in the XML format. As shown at FIG. 5, the XML Engine 520 includes as core components an XML Query Engine 530, a Path Processor 550, and a Store Layer 560. While the following provides a description of the environment 500 with the enhancements of the present invention, a description of known operations of the components can be found in commonly-owned U.S. Pat. No. 6,799,184 titled “Relational Database System Providing XML Query Support”, which is incorporated by reference herein.

The XML Engine 520 includes parse time functionality that transforms each XML document into a collection of bytes that can be stored in a database or file system. Furthermore, a streaming interface over this data is defined to provide fast, random access to the structures within it. The streaming interface includes a fast access structure, which is a flexible interface that enables free movement amongst, and efficient access to the underlying XML data. The XML Engine 520 also has query execution-time functionality for retrieving data in response to queries.

The Path Processor 550 serves as an interface between the XML Query Engine 530 and the Store Layer 560. The Path Processor 550 is an abstract API which accepts path requests from the XML Query Engine 530 and returns back node ids (corresponding to persisted nodes of the XML document). The Path Processor 550 invokes services of the Store Layer 560 to identify the nodes that satisfy the query expression (e.g., XPath expression) and returns an instance of an abstract object named “Dompp”. This Dompp object is returned back to the query layer (i.e., XML Query Engine 530).

The XML Query Engine 530 uses various services of the Dompp such as getValue( ) and/or compare( ) to compute the results of the query. However, the XML Query Engine 530 is not aware of the node ids stored in Dompp. In other words, Dompp acts as a medium to carry node ids through various components of the system.

The Store Layer 560 of the XML Engine 520 converts the text representation into an internal representation which is efficient for storage. The Store Layer 560 is also responsible for converting the representation to its textual form when the Path Processor 550 (path processing layer) requests a certain piece of information during query processing.

XML data is stored in the database system as binary in a parsed format, or as text, or as binary in “raw” XML format. XML document parsing is a fundamental operation in any XML query processing system. However, parsing is a very resource intensive and time-consuming operation as compared to most of the query processing activities. In order to avoid query execution-time parsing overheads, storage of pre-parsed XML documents is utilized. The parsing is achieved through a built-in function, xmlparse( ) The output of xmlparse( ) is an internal format for parsed-XML representation. This format is based on the structures built in memory during parsing. An example of a suitable format is presented in co-pending U.S. patent application Ser. No. 12/488,358, filed Jun. 19, 2009, entitled “Representing Markup Language Document Data in a Searchable Format in a Database System”, and assigned to the assignee of the present invention, the details of which are incorporated herein by reference in their entirety.

As shown at FIG. 5, an XPath query may be transmitted to the XML Engine 520 by the SQL Query Engine 510. For instance, a user may submit the following SQL query requesting information from the database:

{select xmlextract(‘/bookstore/book[title=‘Trenton’]/author/lname’, xmlcol) from bookstoretable}

From the above query, the SQL Query Engine 510 extracts the following XPath portion of the above expression and sends it to the XML Query Engine 530:

/bookstore/book[title=‘ Trenton’]/author/lname

The)(Path portion of the query is handled by the XML Query Engine 530, which includes query execution-time functionality for retrieving data in response to queries. The XML Query Engine 530 includes an XPath parser 531, an optimizer 533, and an execution engine 535. Within the XML Query Engine 530, the XPath parser 531 parses the XPath portion of the query received from the SQL Query Engine 510 and converts it into a query tree representation. The XPath parser 531 includes a normalization module (not separately shown at FIG. 5) for normalization of the XPath expression. The query tree representation generated by the XPath parser 531 is then sent to the optimizer 533 which generates a physical query plan (execution plan) for execution of the query. The query plan is then provided to the execution engine 535 which interprets the query plan and executes it with the support of the store layer 560. It should be noted that although the original query submitted by the user appears to only include a single path, execution of the query plan may break this expression into multiple paths. For instance, a first path may try to extract all the titles while another path may extract the last names, and so on and so forth.

One role of the XML Engine 520 is to transform an XML document for storage in a database. The XML Engine 520 transforms an XML document by analyzing the document as a tree. As described previously with reference to FIG. 4, an XML document can be viewed as a graph where: (1) each element is a node; (2) the text or value (e.g., the value “Mary” as the first name of an author) associated with an element is a leaf node; (3) each attribute (e.g., Style=textbook) is a leaf node; (4) each node is labeled uniquely; and (5) all nodes are labeled in the order they occur in the source document.

During the transformation process, each node is labeled uniquely by assigning an integer to each node in a monotonically increasing order. This integer is referred to as object ID or OID. During this process, each element of the source document is visited in turn and each element is numbered based upon the order it occurs in the document. An object is created by the XML Engine 520 which contains data from the transformed document together with auxiliary structures to aid in faster access to the data. During the transformation process, each element of an XML document is treated as a node or leaf (i.e., terminal node) and these nodes and leaves are annotated to provide faster access to data. The structure of the tree itself is derived from the structure of the source document.

An XML built-in function in ASE, xmltable( ) extracts elements from an XML document to construct a relational table. Xmltable( ) is a generalization of the built-in function, xmlextract. Both functions return data extracted from an XML document that is an argument of the function. But, xmlextract returns the data identified by a single XPath query, while xmltable( ) extracts the sequence or row pattern of the data identified by an XPath query and extracts from each element of that sequence the data identified by a list of other XPath queries, the column definitions. For each existing path matching the row pattern, a column is returned even if there is no matching column definition, i.e. a NULL will be returned. It returns all the data in a SQL table. A single call to xmltable( ) replaces a T-SQL loop performing multiple calls to xmlextract on each iteration and is invoked as a derived table (i.e., a parenthesized subquery specified in the ‘from’ clause of another SQL query). Thus, calling xmltable( ) is equivalent to executing a single xmlextract expression for each row of the table generated by xmltable( ).

The typical syntax of xmltable is as follows:

xmltable_expression ::= xmltable ( row_pattern

passing xml_argument
columns column_definitions
options_parameter)

In this expression, both row_pattern and column_definition could be an XPath query, i.e., xmltable( ) will return a table such that each row should satisfy the XPath specified by the row_pattern, and each column should satisfy the respective XPath specified by the column_definition. Therefore, for a column value in a particular row, both row_pattern and column_pattern should be satisfied. For example,

select * from xmltable (‘/root/a’

passing <xmldoc>
columns col_d int path ‘d/e’, col_c int path ‘c/e’)

as items_table

specifies ‘/root/a’ in the row pattern, and specifies in the columns, col_d with column definition ‘d/e’, and column col_c with column definition ‘c/e’. Thus, for any node in xmldoc, if it satisfies ‘/root/a’, there is one row with two columns, col_d and col_c. Column col_d should satisfy ‘/root/a/d/e’ and column col_c should satisfy ‘/root/a/c/d’. If there is no ‘/root/a/d/e’ and/or ‘/root/a/c/e’, a null value is returned for the particular column in the respective row.

In the XML engine 520, all nodes satisfying the row pattern are retrieved, i.e. all nodes would be retrieved by XPath ‘/root/a’ in the example, to decide the rows in the table. To get the values for each column, the typical approach is traversal, i.e., starting at each node returned from the row pattern, the sub-tree of this particular node is traversed based on the column definition of the query to find out if there is a column value. This tree traversal requires visiting intermediate nodes, which is not very efficient. In the XML engine 520 of ASE, a bottom-up tree traversal is used, but the XML store does not include parent pointers needed for the traversal. In such cases, nodes for the row pattern and nodes for the column definitions are retrieved separately. To match the nodes retrieved from the column definition to a particular row, it is necessary to determine an ancestor-descendant relationship between the nodes retrieved from row pattern and nodes retrieved from a column definition.

By way of example, a path/location-based index is used in the ASE XML store layer 560. Suppose, then, that all nodes indexed by /b or /b/c are known. If a row pattern expression of /b/c is presented, a query of the store layer 560 will return quickly from the index all satisfying nodes for the expression, e.g., R1, R2, and R3. If column definitions of d/f and g are expressed, a query of the store layer 560 will return all nodes indexed by /b/c/d/f (e.g., nodes F1 and F2), and nodes indexed by /b/c/g (e.g., nodes G1, G2, and G3). The nodes returned based on the column definition (F1, F2, G1, G2, G3) and those returned based on the row pattern (R1, R2, R3) now need to be mapped to determine the resultant table for the query.

With only simple XPath expressions as in this example, determining the relationship for the mapping of the columns to the rows may be done based upon the node identifiers. For example, if the OID(R1)<OID(F1)<OID(R2), and OID(R1)<OID(G1)<OID(R2), F1 and G1 are mapped as column 1 and column 2 for the first row, respectively. If OID(R2)<OID(G2)<OID(R3), NULL and G2 are mapped as respective column 1 and column 2 values for the second row. If OID(R3)<OID(F2) and OID(R3)<OID(G3), F2 and G3 are mapped as respective column 1 and column 2 for the third row.

When resolving the ancestor-descendant relationship in the XML engine 520 in this manner, an assumption is made that all nodes from a particular level of the tree for the row pattern are known, which may not be true. When not true, a qualifying column could be missed, leading to inaccurate results in the table.

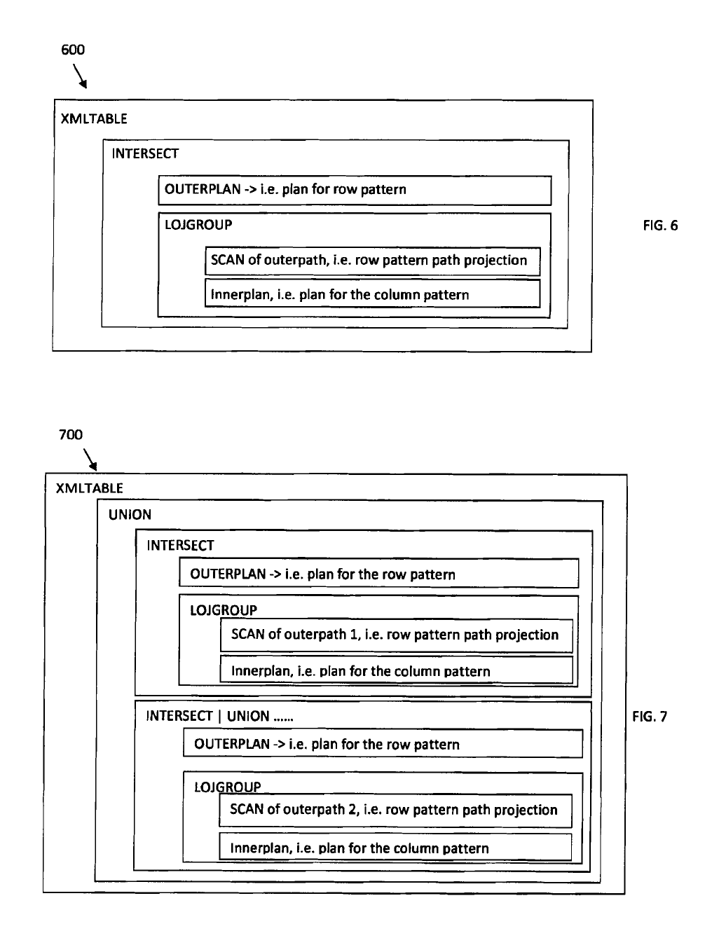

One approach to avoid such inaccuracies is to group row pattern and column pattern like a left outer join (LOJ). By way of example, FIG. 6 is an example execution plan 600 that manipulates the plans for the XMLTABLE for the complex row pattern with an LOJGROUP operator. In the model illustrated, the LOJGROUP operator is similar to the known GROUP operator used in the XML engine except there is always one return for each element from the left hand side, and the OUTERPLAN (i.e., the plan for the row pattern) is compiled independently and is supposed to ‘outer join’ with the inner plan (i.e., the plan for the column pattern) to get the return value for each column. However, if this outer plan were a complex path, it could not be used as the left child of a LOJ group directly. So, an INTERSECT of the OUTERPLAN with a LOJGROUP of the simple outer path scan and inner plan is used. In this manner, the LOJGROUP operator will keep the ancestor-descendent pair for the return. The INTERSECT operator will use the return of LOJGROUP and return any descendent node whose ancestor is also in the return from the OUTERPLAN.

For example, for a complex outer XPath, /a/b[c=3]/d, the OUTERPLAN will get all qualified ‘d’. But under the LOJGROUP, this outer plan is not used, and instead, the scan of simple outer path /a/b/d is used to LOJGROUP with the inner plan. The result would be a superset of the final result, but by intersecting with the OUTERPLAN result, the unwanted results are trimmed out.

This still is not sufficient, however. A problem with this approach is that the LOJGROUP operator is based on the assumption that only a simple path is allowed for the left child (outer part). However, for a complex XPath like /a/(b|c)[d=1]/e, a question arises as to what would be the simple outer path under the LOJGROUP, /a/b/e or /a/c/e. In fact, both of them are needed, but two paths cannot be used for the left child of a LOJGROUP.

To resolve this, two XMLTABLE plans, as that described in FIG. 6, are distributed for each different simple path with a UNION of these different simple path results at the end, as shown in the example execution plan 700 in FIG. 7. While this can be used for a complex XPath with a row pattern like /a/(b|c)[d=1]/e, the plan is very big since the same OUTERPLAN for each INTERSECT has multiple copies.

In accordance with embodiments of the invention, a new approach resolves complex XPath in row pattern of xmltable( ) in an efficient manner. Included in the execution plan are two operators to help simplify the plan. A “UnionAll” operator provides an N-ary UNION operator. Since the OUTERPLAN is always the same, the UnionAll operator is used to UNION all LOJGROUP nodes. An operator “OuterJoin” is also used, since the intersection that is happening involves multiple simple paths. The UnionAll operator will return all distinct ancestor-descendent pairs from all LOJGROUP operators. The OuterJoin operator will use the return from the UnionAll and return any descendent node whose ancestor is also in the return from the OUTERPLAN.

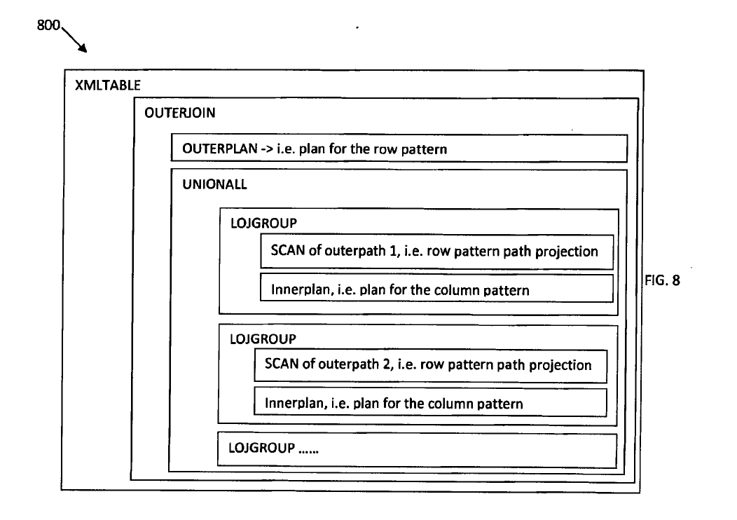

In implementation, an execution plan 800 for this new approach is represented in FIG. 8, and the following presents suitable definitions of the classes for the ‘UnionAll’ and ‘OuterJoin’ operators:

+ class XexecUnionAllOp : public XexecNaryOp
+ {
+ public:

| | |
|---|---|
| + | XexecUnionAllOp( |

| | | |
|---|---|---|
| + | int | primary, |
| + | int | secondary |

| | |
|---|---|
| + | ); |

+

| | |
|---|---|
| + | ~XexecUnionAllOp( ); |

+

| + | /* | |
|---|---|---|
| + | ** Get operator type. This simply returns | |
| + | ** XQE_UNIONALLOP. | |
| + | */ | |
| + | XexecPlanType | |
| + | getType( ) | const; |

+

| + | /* | |
|---|---|---|
| + | ** This is the initialization for UnionAll operator. | |
| + | ** UnionAll can have n-children. It opens all the | |
| + | ** children-plans. | |
| + | */ | |
| + | void | |
| + | open(XexecExecutionContext& | ec); |

+

| + | /* | |
|---|---|---|
| + | ** Iterator to return next result on each call. | |
| + | ** Since this is an N-ary operator, key is the manner of keeping | |
| + | ** the order for the return. | |
| + | */ | |
| + | bool | |
| + | next(XexecExecutionContext& | ec); |

+

| + | void | |
|---|---|---|
| + | opPrint(int indent) | const; |

+

| + | /* | |
|---|---|---|
| + | ** This is supposed to be a sorted operator. | |
| + | */ | |
| + | bool | |
| + | isSortedResult( ) | const; |

+

| + | XexecPlanOp* | |
|---|---|---|
| + | clone(XexecResultContext*, bool) | const; |

+
+ protected:

| + | /* | |
|---|---|---|
| + | ** This is a N-ary operator, so there is a list of result slots | |
| + | ** for its children. | |
| + | */ | |
| + | int* | chResultSlotPri; |
| + | int* | chResultSlotSec; |

+

| | | |
|---|---|---|
| + | int | numChildren; |

+

| | | |
|---|---|---|
| + | bool* | chState; |

+

| | |
|---|---|
| + | XSearchContext* *chResultPri; |

+

| | | |
|---|---|---|
| + | XtreeCompOp | *_same; |
| + | XtreeCompOp | *_greaterThan; |

+ };
+
+ class XexecOuterJoinOp : public XexecBinaryOp
+ {
+ public:

| | |
|---|---|
| + | XexecOuterJoinOp( |

| | | |
|---|---|---|
| + | XexecPlanOp& | lh, |
| + | XexecPlanOp& | rh, |

| | | |
|---|---|---|
| + | int | project |

| | |
|---|---|
| + | ); |

+

| | |
|---|---|
| + | ~XexecOuterJoinOp( ); |

+

| + | XexecPlanType | |
|---|---|---|
| + | getType( ) | const; |

+

| + | void | |
|---|---|---|
| + | open(XexecExecutionContext& | ec); |

+

| + | bool | |
|---|---|---|
| + | next(XexecExecutionContext& | ec); |

+

| + | XexecPlanOp* | |
|---|---|---|
| + | clone(XexecResultContext *rc, bool deepClone) | const; |

+

| + | void | |
|---|---|---|
| + | opPrint(int indent) | const; |

+

| + | bool | |
|---|---|---|
| + | setResult(XexecExecutionContext& | ec); |

+
+ protected:

| | | |
|---|---|---|
| + | XtreeCompOp | *_same; |
| + | XtreeCompOp | *_greaterThan; |

};

By way of example, in an embodiment, an XPath expression with a complex row pattern, ‘/r/(a|x)[k“b1”]/d’, in xmltable( ) executes as:

1> select * from xmltable(‘/r/(a | x)[k=“b1”]/d’ passing
2> “<r><a><k>b1</k><d><b>b1</b><c>2</c></d></a></r>”
3> columns c char(10) path ‘c’, b char(10) path ‘b’) as T

Actual plan output from a running ASE XML engine is provided in the following to illustrate the operation that includes the OuterJoin and UnionAll operators in accordance with an embodiment of the present invention. (Background on other known operators in the plan output is included in the aforementioned U.S. Pat. No. 6,799,184.)

-----------------------------------
XMLTABLE OPERATOR: 0x21605dc0
PROJECTION in 25

-----------------------------------

| NODE TO ATOM VALUE OPERATOR | |
|---|---|
| NVMODE_PRIMARY mode. | PROJECTION in 50 |

-----------------------------------
OuterJoin OPERATOR: 0x2164fbc0
PRIMARY in 49
SECONDARY in 0
LH PRIMARY in 44
RH PRIMARY in 81
RH SECONDARY in 80

```
-----------------------------------
UNION OPERATOR: 0x21630850
PRIMARY in 44
SECONDARY in 0
  LH PRIMARY in 34
  LH SECONDARY in 0
  RH PRIMARY in 43
```

```
-----------------------------------
FILTER OPERATOR: 0x2161c6a0
Path is /r/a
INTERSECT MODE is RHSECONDARY
PRIMARY in 34
SECONDARY in 0
LH PRIMARY in 29
LH SECONDARY in 28
  RH PRIMARY in 33
  RH SECONDARY in 32
```

-----------------------------------
GROUP OPERATOR: 0x2161ba30
PRIMARY in 29
SECONDARY in 28
LH Result in 26
RH Result in 27

-----------------------------------
SCAN OPERATOR: 0x21606200
SIMPLE SCAN ON: /r/a
PROJECTION in 26
-----------------------------------
SCAN OPERATOR: 0x2161b510
PREDICATED SCAN ON: /r/a/k
PREDICATES:

[k=‘b1’]

PROJECTION in 27

-----------------------------------
GROUP OPERATOR: 0x2161c5b0
PRIMARY in 33
SECONDARY in 32
LH Result in 30
RH Result in 31

-----------------------------------
SCAN OPERATOR: 0x2161bb20
SIMPLE SCAN ON: /r/a
PROJECTION in 30
-----------------------------------
SCAN OPERATOR: 0x2161bf20
SIMPLE SCAN ON: /r/a/d
PROJECTION in 31

-----------------------------------
FILTER OPERATOR: 0x2161c320
Path is /r/x
INTERSECT MODE is RHSECONDARY
PRIMARY in 43
SECONDARY in 0
LH PRIMARY in 38
LH SECONDARY in 37
RH PRIMARY in 42
RH SECONDARY in 41

-----------------------------------
GROUP OPERATOR: 0x2161d2d0
PRIMARY in 38
SECONDARY in 37
LH Result in 35
RH Result in 36

-----------------------------------
SCAN OPERATOR: 0x2161ca00
SIMPLE SCAN ON: /r/x
PROJECTION in 35
-----------------------------------
SCAN OPERATOR: 0x2161cdb0
PREDICATED SCAN ON: /r/x/k
PREDICATES:

[k=‘b1’]

PROJECTION in 36

-----------------------------------
GROUP OPERATOR: 0x2161c230
PRIMARY in 42
SECONDARY in 41
LH Result in 39
RH Result in 40

-----------------------------------
SCAN OPERATOR: 0x2161d3c0
SIMPLE SCAN ON: /r/x
PROJECTION in 39
-----------------------------------
SCAN OPERATOR: 0x2161d7c0
SIMPLE SCAN ON: /r/x/d
PROJECTION in 40

-----------------------------------
UnionAll Operator: 0x216686b0
Primary result in81
Secondary result in80

-----------------------------------
LOJ GROUP OPERATOR: 0x2164fad0
PRIMARY in 48
SECONDARY in 47
LH Result in 46
RH Result in 45

-----------------------------------
SCAN OPERATOR: 0x2164f850
SIMPLE SCAN ON: /r/x/d
PROJECTION in 46
-----------------------------------
SCAN OPERATOR: 0x21620eb0
SIMPLE SCAN ON: /r/x/d/b
PROJECTION in 45

```
  -----------------------------------
  LOJ GROUP OPERATOR: 0x216685c0
  PRIMARY in 79
  SECONDARY in 78
  LH Result in 77
  RH Result in 76
```

-----------------------------------
SCAN OPERATOR: 0x21668150
SIMPLE SCAN ON: /r/a/d
PROJECTION in 77

| ----------------------------------- | |
|---|---|
| SCAN OPERATOR: 0x216680b0 | |
| SIMPLE SCAN ON: /r/a/d/b | |
| PROJECTION in 76 | |
| ---------------------------------- | |
| NODE TO ATOM VALUE OPERATOR | |
| NVMODE_PRIMARY mode. | PROJECTION in 75 |

-----------------------------------
OuterJoin OPERATOR: 0x21656110
PRIMARY in 74
SECONDARY in 0
LH PRIMARY in 69
RH PRIMARY in 87
RH SECONDARY in 86

-----------------------------------
UNION OPERATOR: 0x21652a60
PRIMARY in 69
SECONDARY in 0
LH PRIMARY in 59
LH SECONDARY in 0
RH PRIMARY in 68

-----------------------------------
FILTER OPERATOR: 0x216514a0
Path is /r/a
INTERSECT MODE is RHSECONDARY
PRIMARY in 59
SECONDARY in 0
LH PRIMARY in 54
LH SECONDARY in 53
RH PRIMARY in 58
RH SECONDARY in 57

-----------------------------------
GROUP OPERATOR: 0x21650830
PRIMARY in 54
SECONDARY in 53
LH Result in 51
RH Result in 52

-----------------------------------
SCAN OPERATOR: 0x2164fce0
SIMPLE SCAN ON: /r/a
PROJECTION in 51
-----------------------------------
SCAN OPERATOR: 0x21650310
PREDICATED SCAN ON: /r/a/k
PREDICATES:

[k=‘b1’]

PROJECTION in 52

-----------------------------------
GROUP OPERATOR: 0x216513b0
PRIMARY in 58
SECONDARY in 57
LH Result in 55
RH Result in 56

-----------------------------------
SCAN OPERATOR: 0x21650920
SIMPLE SCAN ON: /r/a
PROJECTION in 55
-----------------------------------
SCAN OPERATOR: 0x21650d20
SIMPLE SCAN ON: /r/a/d
PROJECTION in 56

-----------------------------------
FILTER OPERATOR: 0x21650060
Path is /r/x
INTERSECT MODE is RHSECONDARY
PRIMARY in 68
SECONDARY in 0
LH PRIMARY in 63
LH SECONDARY in 62
RH PRIMARY in 67
RH SECONDARY in 66

-----------------------------------
GROUP OPERATOR: 0x216520d0
PRIMARY in 63
SECONDARY in 62
LH Result in 60
RH Result in 61

-----------------------------------
SCAN OPERATOR: 0x21651800
SIMPLE SCAN ON: /r/x
PROJECTION in 60
-----------------------------------
SCAN OPERATOR: 0x21651bb0
PREDICATED SCAN ON: /r/x/k
PREDICATES:

[k=‘b1’]

PROJECTION in 61

-----------------------------------
GROUP OPERATOR: 0x216211a0
PRIMARY in 67
SECONDARY in 66
LH Result in 64
RH Result in 65

-----------------------------------
SCAN OPERATOR: 0x216521c0
SIMPLE SCAN ON: /r/x
PROJECTION in 64
-----------------------------------
SCAN OPERATOR: 0x216510a0
SIMPLE SCAN ON: /r/x/d
PROJECTION in 65

-----------------------------------
UnionAll Operator: 0x21668ff0
Primary result in87
Secondary result in86

-----------------------------------
LOJ GROUP OPERATOR: 0x21656020
PRIMARY in 73
SECONDARY in 72
LH Result in 71
RH Result in 70

-----------------------------------
SCAN OPERATOR: 0x21655bb0
SIMPLE SCAN ON: /r/x/d
PROJECTION in 71
-----------------------------------
SCAN OPERATOR: 0x21655b10
SIMPLE SCAN ON: /r/x/d/c
PROJECTION in 70

-----------------------------------
LOJ GROUP OPERATOR: 0x21668f00
PRIMARY in 85
SECONDARY in 84
LH Result in 83
RH Result in 82

-----------------------------------
SCAN OPERATOR: 0x21668a90
SIMPLE SCAN ON: /r/a/d
PROJECTION in 83
-----------------------------------
SCAN OPERATOR: 0x216689f0
SIMPLE SCAN ON: /r/a/d/c
PROJECTION in 82

| c | b |
|---|---|
| -------- ---------- | |
| 2 | b1 |

(1 row affected)

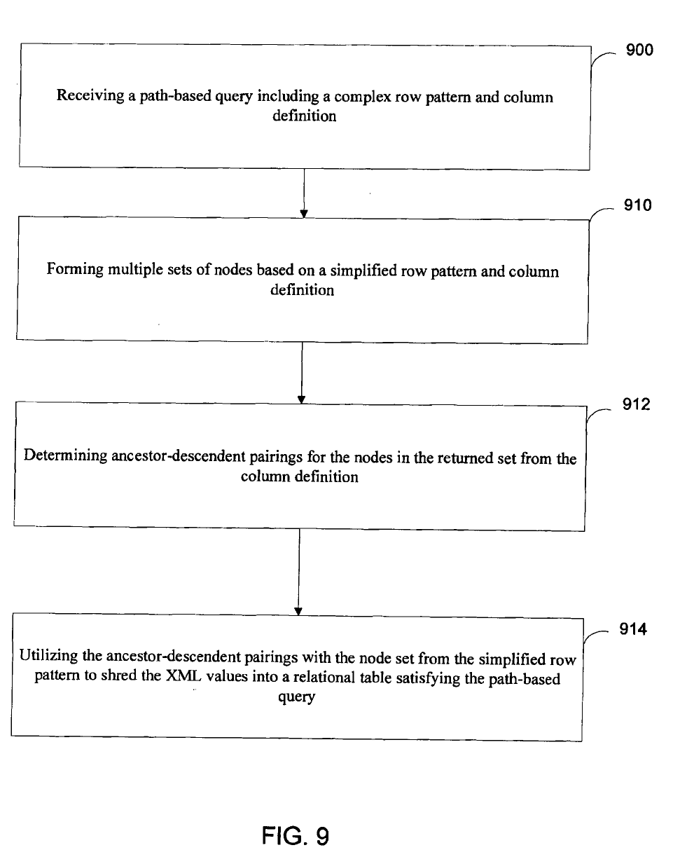

In this example, the execution produces a table having two columns, ‘c’ and ‘b’, with a row having the value ‘2’ in column ‘c’ and the value ‘b1’ in column ‘b’. An overall block representation of the execution process is presented with reference to FIG. 9. In the processing, a path-based query including a complex row pattern and column definition is received (block 900), and multiple sets of nodes based on a simplified row pattern and column definition of the path-based query are formed (block 910), where the simplified row pattern results from projection of the complex row pattern to simple paths. The process further includes determining ancestor-descendent pairings for the nodes in the returned set from the column definition (block 912). This includes aggregating the ancestor-descendent pairings with the ‘unionall’ operations. These pairings are utilized with the set from the simplified row pattern to shred the XML nodes values into a relational table satisfying the path-based query (block 914) through the outer joining execution.

In this manner, an efficient and effective solution is provided for complex XPath query processing in a database system. The approach ensures a compact execution plan that avoids inaccuracies for ancestor-descendent pairing identification and successfully achieves shredding of information in XML documents into relational tables. The achievement occurs through new operators directly for an XML engine and not a rewriting of some part of XPath.

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance. The breadth and scope of the present invention should not be limited by any of the above-described exemplary embodiments, but should be defined only in accordance with the following claims and their equivalents.

What is claimed is:

1. A computer-implemented method for executing a function in a path-based query when extracting data from a markup language document for return as a relational table, the markup language document organized hierarchically into nodes, the method comprising:
receiving a path-based query including a complex row pattern and column definition;
forming multiple sets of nodes based on a simplified row pattern and column definition;
determining ancestor-descendent pairings for the nodes in the column definition set; and
utilizing the ancestor-descendent pairings with the simplified row pattern to return a relational table satisfying the complex path-based query.

2. The computer-implemented method of claim 1 wherein forming further comprises projecting the row pattern to simple paths.

3. The computer-implemented method of claim 2 wherein determining further comprises aggregating ancestor-descendent pairings based on the simple paths and the column definition nodes.

4. The computer-implemented method of claim 3 wherein utilizing further comprises outer joining the simplified row pattern nodes with the ancestor-descendent pairings to extract node values for the relational table.

5. The computer-implemented method of claim 3 wherein aggregating further comprises performing a unionall operation.

6. The computer-implemented method of claim 1 wherein the markup language comprises extensible markup language (XML).

7. The computer-implemented method of claim 1 wherein the complex path based query comprises an XPath query expression.

8. A system capable of executing a function in a path-based query when extracting data from a markup language document for return as a relational table, the markup language document organized hierarchically into nodes, the system comprising:
a storage module for storing a markup language document; and
a processing module coupled to the storage module for forming multiple sets of nodes based on a simplified row pattern and column definition of a path-based query having a complex row pattern and column definition, determining ancestor-descendent pairings for the nodes in the column definition set, and utilizing the ancestor-descendent pairings with the simplified row pattern to return a relational table satisfying the complex path-based query.

9. The system of claim 8 wherein the processing module further projects the complex row pattern to simple paths.

10. The system of claim 9 wherein the processing module further aggregates ancestor-descendent pairings based on the simple paths and the column definition nodes.

11. The system of claim 10 wherein the processing module further outer joins the simplified row pattern nodes with the ancestor-descendent pairings to extract node values for the relational table.

12. The system of claim 10 wherein the processing module further aggregates by performing a unionall operation.

13. The system of claim 8 wherein the markup language comprises extensible markup language (XML).

14. The system of claim 8 wherein the path based query comprises an XPath query expression.

15. A computer program product comprising a computer usable medium having computer program logic recorded thereon for enabling a processor to execute a function in a path-based query when extracting data from a markup language document for return as a relational table, the markup language document organized hierarchically into nodes, the computer program logic comprising:
means for enabling a processor to receive a path-based query including a complex row pattern and column definition;
means for enabling a processor to form multiple sets of nodes based on a simplified row pattern and column definition;
means for enabling a processor to determine ancestor-descendent pairings for the nodes in the column definition set; and
means for enabling a processor to utilize the ancestor-descendent pairings with the simplified row pattern to return a relational table satisfying the complex path-based query.

16. The computer program logic of claim 15 wherein the means for enabling a processor to form multiple sets further comprises means for enabling a processor to project the row pattern to simple paths.

17. The computer program logic of claim 16 further comprising means for enabling a processor to aggregate ancestor-descendent pairings based on the simple paths and the column definition nodes.

18. The computer program logic of claim 17 further comprising means for enabling a processor to outer join the simplified row pattern nodes with the ancestor-descendent pairings to extract node values for the relational table.

19. The computer program logic of claim 17 wherein the means for enabling a processor to aggregate further comprises means for enabling a processor to perform a unionall operation.

20. The computer program logic of claim 15 wherein the markup language comprises extensible markup language (XML) and the path based query comprises an XPath query expression.
